(19) United States
(12) Patent Application Publication
(10) Pub. No.: US 2007/0046572 A1
(43) Pub. Date: Mar. 1, 2007

(54) Plasma display panel (PDP)

(76) Inventor: Kyoung-Doo Kang, Suwon-si (KR)

Correspondence Address: Robert E. Bushnell, Suite 300, 1522 K Street, N.W., Washington, DC, 20005-1202, US

(21) Appl. No.: 11/496,630

(22) Filed: Aug. 1, 2006

(30) Foreign Application Priority Data
Aug. 26, 2005 (KR) 10-2005-0078717

(51) Int. Cl. G09G 3/28

(52) U.S. Cl. 345/63

(57) ABSTRACT

A Plasma Display Panel (PDP) having improved brightness and discharge efficiency includes: a first substrate and a second substrate separated from each other; barrier ribs disposed between the first substrate and the second substrate and defining a plurality of discharge cells together with the first substrate and the second substrate; a plurality of first electrodes and a plurality of second electrodes disposed in the barrier ribs and extending in a first direction parallel to each other; a plurality of address electrodes disposed in the barrier ribs and extending in a second direction intersecting the first direction; a plurality of phosphor layers disposed in the discharge cells; and a discharge gas contained within the discharge cells. A unit frame is divided into a plurality of subfields having corresponding gray-scale weights for gray-scale display, each subfield is divided into a reset period in which the discharge cells are initialized, an address period in which discharge cells to be turned on are selected, and a sustain period in which a sustain discharge corresponding to the gray-scale weights occurs in the selected discharge cells, and in the sustain period, either a sustain pulse alternately having a first voltage with positive polarity and a second voltage lower than the first voltage is alternately supplied to the first electrodes and the second electrodes, and a third voltage with positive polarity is supplied to the address electrodes, or the address electrodes are floating.

### CLAIM OF PRIORITY

This application makes reference to, incorporates the same herein, and claims all benefits accruing under 35 U.S.C. §119 from an application for PLASMA DISPLAY PANEL earlier filed in the Korean Intellectual Property Office on the 26 of Aug. 2005 and there duly assigned Serial No. 10-2005-0078717.

### BACKGROUND OF THE INVENTION

1. Field of the Invention

The present invention relates to a Plasma Display Panel (PDP), and more particularly, to a PDP which is capable of enhancing brightness and discharge efficiency when a discharge is effected.

2. Description of the Related Art

Recently, Plasma Display Panels (PDPs) have come to public attention, as replacements for conventional cathode ray tubes (CRTs). In a PDP, a discharge gas is filled between two substrates on which a plurality of electrodes are formed, a discharge voltage is applied to the electrodes, phosphor formed with a predetermined pattern is excited due to ultraviolet rays generated by the discharge voltage, and thus a desired image is displayed.

A 3-electrode surface discharge PDP includes a first panel and a second panel. The first panel includes a first substrate, a first dielectric layer which covers a plurality of scanning electrodes and a plurality of sustain electrodes formed on a rear surface of the first substrate, and a first protection film for protecting the first dielectric layer. A scan electrode and a sustain electrode form a pair of sustain electrodes. The scan electrode consists of a bus electrode formed of a metal material for enhancing conductivity and a transparent electrode formed of a transparent conductive material, such as Indium Tin Oxide (ITO). The sustain electrode consists of a bus electrode formed of a metal material for enhancing conductivity and a transparent electrode formed of a transparent conductive material, such as ITO.

The second panel includes a second substrate, a second dielectric layer which is disposed on a front surface of the second substrate facing the first substrate to cover a plurality of address electrodes formed in a direction intersecting a direction in which the scan electrodes and the sustain electrodes extend, barrier ribs which are disposed on the second dielectric layer and partition discharge cells, phosphor layers which are disposed in spaces partitioned by the barrier ribs, and a second protection film which is formed on front surfaces of the phosphor layers to protect the phosphor layers. The spaces partitioned by the barrier ribs define discharge cells Ce and a discharge gas is injected into the discharge cells Ce.

Predetermined voltages are supplied to the respective electrodes of such a PDP, a discharge occurs in the discharge cells Ce, ultraviolet rays are generated by the discharge, the phosphor layers are excited by the ultraviolet rays, and visible light is emitted. The discharge can be divided into an address discharge for selecting discharge cells to be turned on and a sustain discharge for maintaining discharge in the selected discharge cells. The address discharge is generated between the scan electrodes and the address electrodes, and the sustain discharge is generated between the scan electrodes and the sustain electrodes. However, since intervals between the scan electrodes and the sustain electrodes are narrow in the 3-electrode surface discharge, a discharge volume is small when a sustain discharge is performed, and brightness deteriorates due to the small discharge volume. Also, discharge efficiency needs to be improved.

### SUMMARY OF THE INVENTION

The present invention provides a Plasma Display Panel (PDP) having improved resolution.

According to an aspect of the present invention, a Plasma Display Panel (PDP) is provided including: a first substrate and a second substrate separated from each other; barrier ribs disposed between the first substrate and the second substrate and defining a plurality of discharge cells together with the first substrate and the second substrate; a plurality of first electrodes and a plurality of second electrodes disposed in the barrier ribs and extending in a first direction parallel to each other; a plurality of address electrodes disposed in the barrier ribs and extending in a second direction intersecting the first direction; a plurality of phosphor layers disposed in the discharge cells; and a discharge gas contained within the discharge cells; a unit frame is divided into a plurality of subfields having corresponding gray-scale weights for gray-scale display, each subfield being divided into a reset period in which the discharge cells are initialized, an address period in which discharge cells to be turned on are selected, and a sustain period in which a sustain discharge corresponding to the gray-scale weights occurs in the selected discharge cells, and either a sustain pulse alternately having a first voltage with positive polarity and a second voltage lower than the first voltage is alternately supplied to the first electrodes and the second electrodes in the sustain period, and a third voltage with positive polarity is supplied to the address electrodes in the sustain period, or the address electrodes are floating in the sustain period.

The first electrodes, the second electrodes, and the address electrodes preferably surround the discharge cells. The address electrodes are preferably disposed between the first electrodes and the second electrodes, within the barrier ribs.

The phosphor layers are preferably disposed on one or both the first and second substrates.

A reset pulse consisting of a rising pulse and a falling pulse is preferably supplied to the first electrodes during the reset period, a fourth voltage with positive polarity is preferably supplied to the second electrodes from when the falling pulse is supplied during the reset period, and a second voltage is preferably supplied to the address electrodes during the reset period; and a scan pulse is preferably supplied to the first electrodes during the address period, the fourth voltage is preferably supplied to the second electrodes during the address period, and an address pulse is preferably supplied to the address electrodes in synchronism with the scan pulse during the address period.

The rising pulse preferably rises by a fifth voltage from the first voltage and finally reaches a sixth voltage, and the falling pulse preferably falls from the first voltage and finally reaches a seventh voltage; the scan pulse sequentially preferably has an eighth voltage and a ninth voltage lower than the eighth voltage; and the address pulse preferably has a tenth voltage with a positive polarity.

The third voltage is preferably lower than the first voltage. The second voltage is preferably a ground voltage.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partially sectional perspective view of a 3-electrode surface discharge Plasma Display Panel (PDP);

FIG. 2 is a cross-sectional view of the PDP of FIG. 1 taken along a line II-II;

FIG. 3 is a partially sectional perspective view of a PDP according to an embodiment of the present invention;

FIG. 4 is a cross-sectional view of the PDP of FIG. 3 taken along a line III-III;

FIG. 5 is a view of an arrangement of discharge cells and electrodes of FIG. 3 according to an embodiment of the present invention;

FIG. 6 is a block diagram of an apparatus for driving the PDP of FIG. 3;

FIG. 7 is a timing diagram of driving signals for driving the PDP of FIG. 3, according to an embodiment of the present invention; and

FIG. 8 is a timing diagram of driving signals for driving the PDP of FIG. 3, according to another embodiment of the present invention.

### DETAILED DESCRIPTION OF THE INVENTION

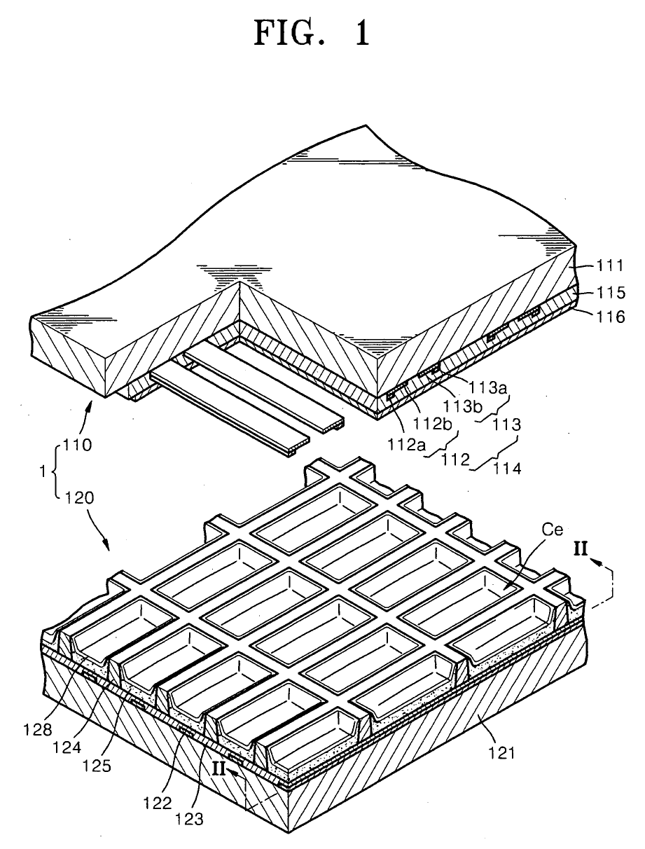

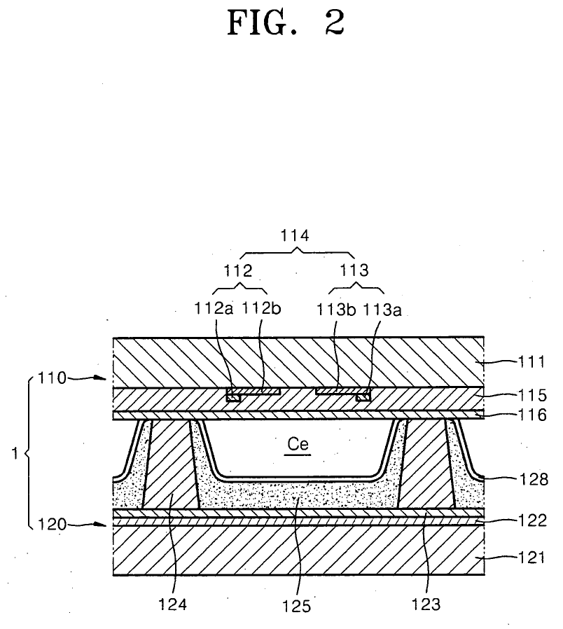

FIG. 1 is a partially sectional perspective view of a 3-electrode surface discharge Plasma Display Panel (PDP) 1. FIG. 2 is a cross-sectional view of the PDP 1 of FIG. 1 taken along a line II-II.

Hereinafter, the 3-electrode surface discharge PDP 1 is described with reference to FIGS. 1 and 2.

Referring to FIG. 1, the PDP 1 includes a first panel 110 and a second panel 120.

The first panel 110 includes a first substrate 111, a first dielectric layer 115 which covers a plurality of scanning electrodes 112 and a plurality of sustain electrodes 113 formed on a rear surface of the first substrate 111, and a first protection film 116 for protecting the first dielectric layer 115. A scan electrode 112 and a sustain electrode 113 form a pair of sustain electrodes 114. The scan electrode 112 consists of a bus electrode 112a formed of a metal material for enhancing conductivity and a transparent electrode 112b formed of a transparent conductive material, such as Indium Tin Oxide (ITO). The sustain electrode 113 consists of a bus electrode 113a formed of a metal material for enhancing conductivity and a transparent electrode 113b formed of a transparent conductive material, such as ITO.

The second panel 120 includes a second substrate 121, a second dielectric layer 123 which is disposed on a front surface of the second substrate 121 facing the first substrate 111 to cover a plurality of address electrodes 122 formed in a direction intersecting a direction in which the scan electrodes 112 and the sustain electrodes 113 extend, barrier ribs 124 which are disposed on the second dielectric layer 123 and partition discharge cells, phosphor layers 125 which are disposed in spaces partitioned by the barrier ribs 124, and a second protection film 128 which is formed on front surfaces of the phosphor layers 125 to protect the phosphor layers 125. The spaces partitioned by the barrier ribs 124 define discharge cells Ce and a discharge gas is injected into the discharge cells Ce.

Predetermined voltages are supplied to the respective electrodes of the PDP 1 of FIG. 1, a discharge occurs in the discharge cells Ce, ultraviolet rays are generated by the discharge, the phosphor layers 125 are excited by the ultraviolet rays, and visible light is emitted. The discharge can be divided into an address discharge for selecting discharge cells to be turned on and a sustain discharge for maintaining discharge in the selected discharge cells. The address discharge is generated between the scan electrodes 112 and the address electrodes 122, and the sustain discharge is generated between the scan electrodes 112 and the sustain electrodes 113. However, since intervals between the scan electrodes 112 and the sustain electrodes 113 are narrow in the 3-electrode surface discharge PDP 1 of FIG. 1, a discharge volume is small when a sustain discharge is performed, and brightness deteriorates due to the small discharge volume. Also, discharge efficiency needs to be improved.

The present invention is described below more fully with reference to the accompanying drawings, in which exemplary embodiments of the present invention are shown.

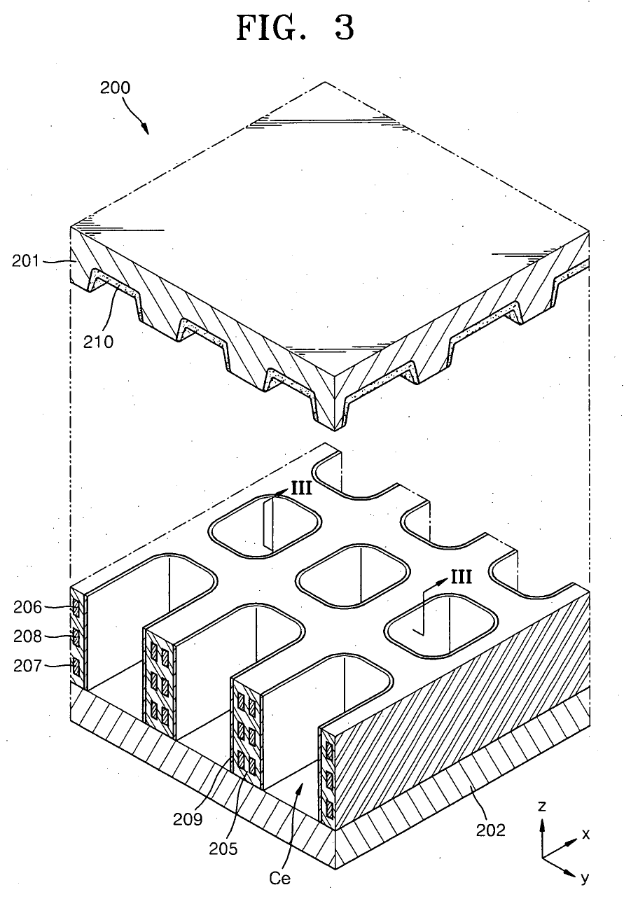

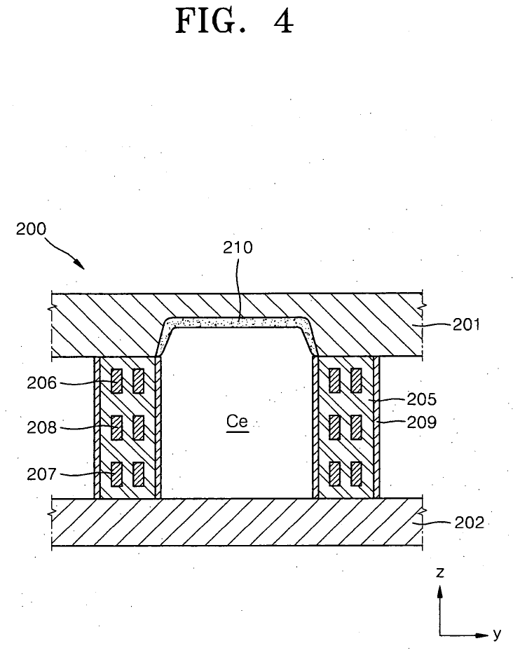

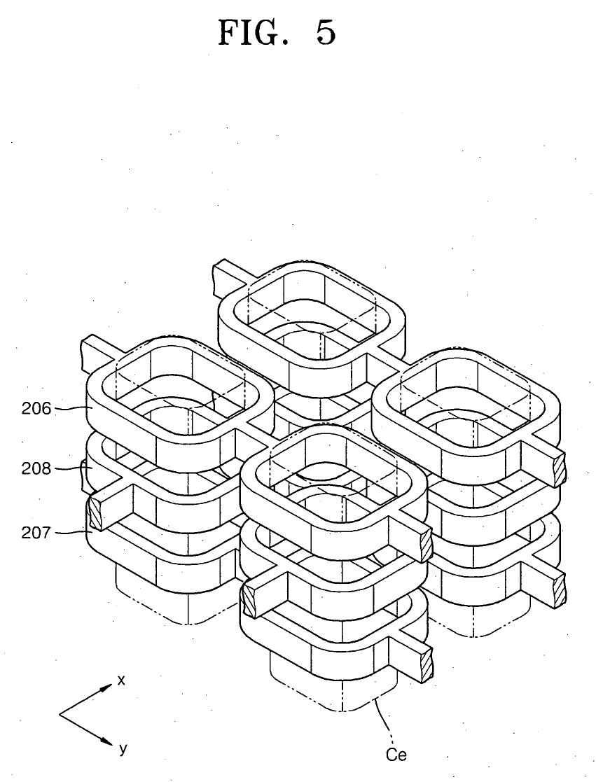

FIG. 3 is a partially sectional perspective view of a PDP 200 according to an embodiment of the present invention. FIG. 4 is a cross-sectional view of the PDP of FIG. 3 taken along a line III-III. FIG. 5 is a view of an arrangement of discharge cells and electrodes of FIG. 3 according to an embodiment of the present invention. Hereinafter, the PDP 200 according to an embodiment of the present invention is described with reference to FIGS. 3, 4, and 5.

The PDP 200 includes a first substrate 201, a second substrate 202, barrier ribs 205, first electrodes 206, second electrodes 207, address electrodes 208, phosphor layers 210, and a discharge gas (not shown).

The first substrate 201 and the second substrate 202 are separated from each other by a predetermined distance and are opposite to each other. In the PDP 200 according to the current embodiment of the present invention, visible light generated by the discharge cells can be discharged through either the first substrate 201 or the second substrate 202. Accordingly, at least one of the first substrate 201 and the second substrate 202 is a transparent substrate formed of a material having high light transparency, such as glass. However, the present invention is not limited to this, and at least one of the first substrate 201 and the second substrate 202 can be formed of an arbitrary material capable of sufficiently transmitting visible light.

Since the first substrate 201 does not include the scan electrodes 112, the sustain electrodes 113, and the first dielectric layer 115 which exist on the front substrate 110 of the PDP 1 of FIG. 1, visible light transparency can be significantly improved. That is, the visible light transparency of the PDP 1 is about 60%, while the visible light transparency of the PDP 200 according to the current embodiment of the present invention exceeds 90%. As a result, according to the current embodiment of the present invention, light emitting efficiency is improved.

The barrier ribs 205 are disposed between the first substrate 201 and the second substrate 202 and partition a plurality of discharge cells Ce. The discharge cells Ce partitioned by the barrier ribs 205 have an oval cross-section and are arranged in a matrix form. However, the structure of the barrier ribs 205 is not limited to this. That is, the barrier ribs 205 can be formed in various patterns, such as a waffle pattern, a delta pattern, etc., which can form a plurality of discharge spaces. Also, the cross-section of the discharge spaces can be a polygon, such as a triangle, a square, a pentagon, etc., or a circle, rather than the oval cross-section. The barrier ribs 205 prevent an unwanted discharge from occurring between the discharge cells Ce.

As illustrated in FIGS. 4 and 5, the first electrodes 206, the address electrodes 208, and the second electrodes 207 are disposed to surround the discharge cells Ce. The first electrodes 206, the address electrodes 208, and the second electrodes 207 are separated from each other, and, in the current embodiment of the present invention, are separated from each other in a z direction. That is, the second electrodes 207, the address electrodes 208, and the first electrodes 206 are disposed in this order with predetermined spaces between the first electrodes 206 and the first substrate 201, and between the second electrodes 207 and the second substrate 202 (in the z direction). The first electrodes 206, the address electrodes 208, and the second electrodes 207 are formed of a conductive metal, such as aluminum, silver, copper, etc.

The first electrodes 206 and the second electrodes 207 extend in a first direction (y direction) and the address electrodes 208 extend in a second direction (x direction) intersecting the first direction.

The barrier ribs 205 prevent a current from directly flowing through the first electrodes 206, the address electrodes 208, and the second electrodes 207 when a discharge occurs, and also prevent charged particles from directly colliding with and damaging the first electrodes 206, the address electrodes 208, and the second electrodes 207. Also, the barrier ribs 205 are formed of a dielectric material which can accumulate charged particles as wall charges. Such dielectric materials include PbO, B₂O₃, SiO₂. etc.

Sides of the barrier ribs 205 can be covered with a MgO layer 209 which is a protection layer. In the current embodiment of the present invention, the MgO layer 209 prevents the barrier ribs 205 formed of the dielectric material from being damaged and accelerates the discharge of secondary electrons when a discharge occurs. The MgO layer 209 is formed as a thin film by sputtering or E-beam evaporation.

In the current embodiment of the present invention, the phosphor layers 210 are disposed in the discharge cells Ce. The phosphor layers 210 can be positioned at arbitrary locations in the discharge cells Ce. For example, the phosphor layers 210 are formed on one or both of the first and second substrates 201 and 202. In FIGS. 3 and 4, the phosphor layers 210 are disposed on a rear surface of the first substrate 201 facing the second substrate 202. The phosphor layers 210 include a red-emitting phosphor layer, a green-emitting phosphor layer, and a blue-emitting phosphor layer.

The phosphor layers 210 include components for receiving ultraviolet rays generated by a discharge between the first electrodes 206, the address electrodes 208, and the second electrodes 207 and emit visible light. The red-emitting phosphor layer includes a phosphor such as Y(V,P)O₄:Eu, etc., the green-emitting phosphor layer includes a phosphor such as Zn₂SiO₄:Mn, YBO₃:Tb, etc., and the blue-emitting phosphor layer includes a phosphor such BAM:Eu, etc.

The discharge cells Ce are filled with a discharge gas, such as Ne, Xe, a mixture of Ne and Xe, etc. and are then sealed.

In the PDP 1 of FIG. 1, since a sustain discharge between the sustain electrodes 113 and the scan electrodes 112 occurs in a horizontal direction near the first substrate 111, a discharge area is relatively narrow. However, in the PDP 200 according to the current embodiment of the present invention, since a sustain discharge occurs on all sides of the discharge cells Ce, a discharge area is relatively wide. Furthermore, in the current embodiment of the present invention, a sustain discharge occurs in the form of a closed curve along the sides of each discharge cell Ce and then is gradually diffused into the center of the discharge cell Ce. Thus, the volumes of areas in which a sustain discharge occurs increase, and space charges in discharge cells, which are normally not utilized, contribute to light emission. As a result, the light-emitting efficiency of a PDP can be improved.

The first electrodes 206 can be used as sustain electrodes and the second electrodes 207 can be used as scan electrodes, or vice versa. Hereinafter, it is assumed that the first electrodes 206 are used as sustain electrodes and the second electrodes 207 are used as scan electrodes.

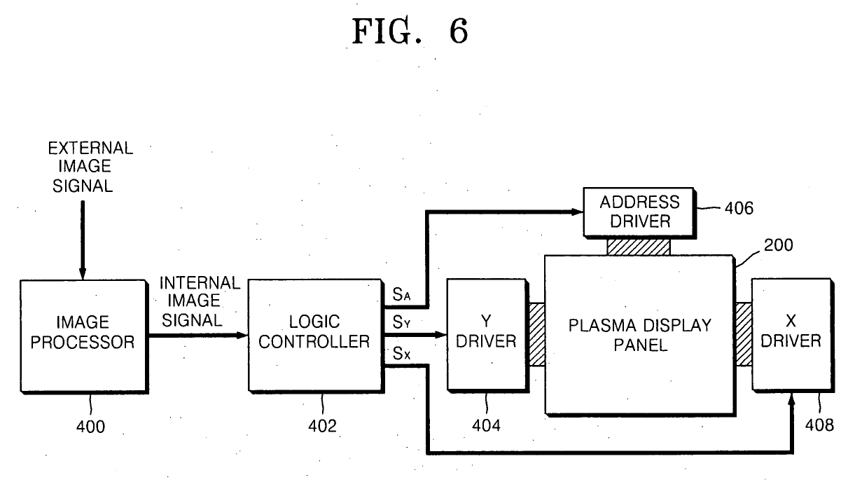

FIG. 6 is a block diagram of an apparatus for driving the PDP 200 of FIG. 3.

The PDP driving apparatus includes an image processor 400, a logic controller 402, a Y driver 404, an address driver 406, an X driver 408, and a PDP 200.

The image processor 400 receives external analog image signals, such as PC signals, DVD signals, video signals, TV signals, etc., converts the analog signals into digital signals, performs image-processing on the digital signals, and outputs internal image signals. The internal image signals are red (R), green (G), and blue (B) 8-bit data image signals, a clock signal, and vertical and horizontal synchronization signals.

The logic controller 402 receives the internal image signals from the image processor 400, performs gamma-correction, Automatic Power Control (APC), etc. on the internal image signals, and outputs an address driving control signal SA, a Y driving control signal SY, and an X driving control signal SX.

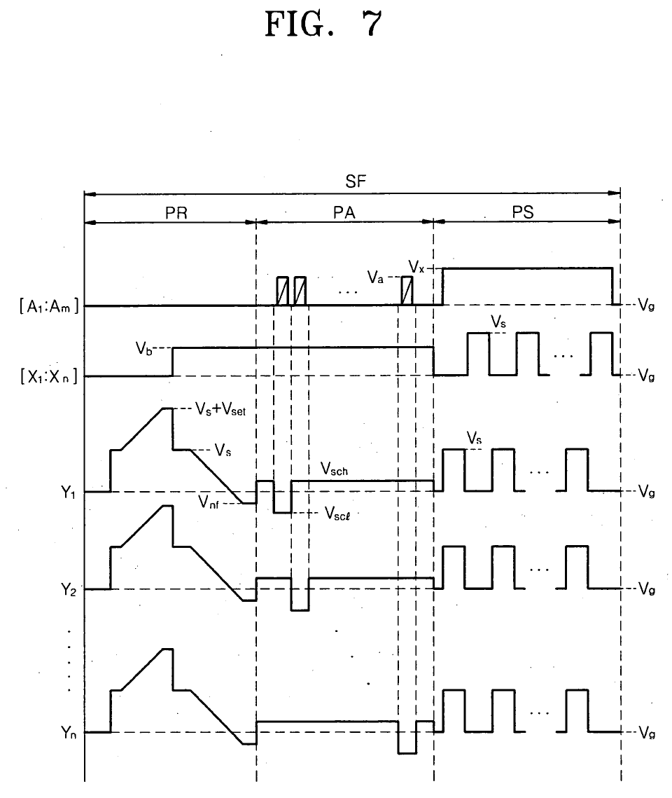

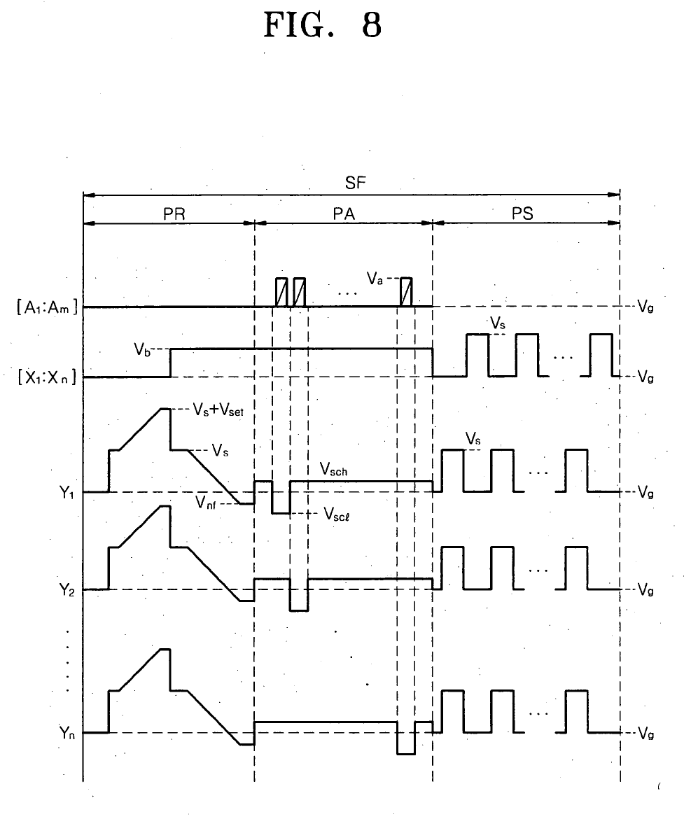

The Y driver 404 receives the Y driving control signal SY from the logic controller 402, supplies a reset pulse consisting of a rising pulse and a falling pulse for initialization discharge during a reset period (PR of FIG. 7 or 8), a scan pulse during an address period (PA of FIG. 7 or 8), and a sustain pulse during a sustain period (PS of FIG. 7 or 8), to scan electrodes (Y₁, . . . Yₙ of FIG. 7 or 8) of the PDP 200.

The address driver 406 receives the address driving signal SA from the logic controller 402, and outputs the address pulse to the address electrodes (A₁, . . . , Aₘ of FIG. 7 or 8) of the PDP 200, to select the discharge cells to be turned on during the address period PA.

The X driver 408 receives the X driving control signal SX from the logic controller 402, supplies a bias voltage (V_{b} of FIG. 7 or 8) during the reset period PR and the address period PA, and supplies a sustain pulse during the sustain period PS, to sustain electrodes (X₁, . . . , Xₙ of FIG. 7 or 8) of the PDP 200.

FIG. 7 is a timing diagram of driving signals for driving the PDP 300 of FIG. 3, according to an embodiment of the present invention. Hereinafter, the driving signals for driving the PDP 200 of FIG. 3 are described with reference to FIGS. 3 through 7.

Referring to FIG. 7, in the sustain period PS, a sustain pulse alternately having a first positive voltage Vₛ and a second positive voltage V_{g} is supplied alternately to the scan electrodes Y₁, . . . , Yₙ and the sustain electrodes X₁, . . . , Xₙ, and a third positive voltage Vₓ is supplied to the address electrodes A₁, . . . , Aₘ.

The PDP 200 creates an image per each frame at 60 Hz or 50 Hz. Each frame consists of a plurality of subfields. Gray scale weights for time division gray-scale display are assigned to the respective subfields. Each subfield SF is divided into a reset period PR, an address period PA, and a sustain period PS.

In a reset period PR in which all of the discharge cells are initialized, a reset pulse consisting of a rising pulse and a falling pulse is supplied to the scan electrodes Y₁, . . . , Yₙ, a fourth positive voltage V_{b} is supplied to the sustain electrodes X₁, . . . , Xₙ when the falling pulse is supplied, and the second voltage V_{g} is supplied to the address electrodes A₁, . . . , Aₘ. The rising pulse gradually rises by a fifth voltage Vₛₑₜ from a first voltage Vₛ, thus finally reaching a sixth voltage Vₛₑₜ+Vₛ. The falling pulse gradually falls from the first voltage Vₛ, thus finally reaching a seventh voltage V_{nf}.

By supplying the rising pulse, negative wall charges are accumulated near the scan electrodes Y₁, . . . , Yₙ in the discharge cells and positive wall charges are accumulated near the sustain electrodes X₁, . . . , Xₙ and the address electrodes A₁, . . . , Aₘ, and a weak discharge occurs. By supplying the falling pulse, the wall charges accumulated near the respective electrodes in the discharge cells are erased, and a weak discharge occurs. When the reset period PR is terminated, a small amount of negative wall charges are accumulated near the scan electrodes Y₁, . . . , Yₙ, negative wall charges are accumulated near the sustain electrodes X₁, . . . , Xₙ, and a small amount of positive wall charges are accumulated near the address electrodes A₁, . . . , Aₘ.

In the address period PA, discharge cells to be turned on are selected and an address discharge occurs in the selected discharge cells. A scan pulse is sequentially supplied to the scan electrodes Y₁, . . . , Yₙ, an address pulse is supplied to the address electrodes A₁, . . . , Aₘ in synchronism with the scan pulse, and the fourth positive voltage V_{b} is supplied to the sustain electrodes X₁, . . . , Xₙ. The scan pulse is maintained at an eighth positive voltage V_{sch} and then falls to a ninth voltage V_{scl}, smaller than the eighth voltage V_{sch}. The address pulse has a tenth voltage Vₐ when discharge cells to be turned on in synchronism with the scan pulse are selected, and has the second positive voltage V_{g} when discharge cells not to be turned on in synchronism with the scan pulse are selected.

By supplying the scan pulse and the address pulse, an address discharge occurs between the scan electrodes Y₁, . . . , Yₙ and the address electrodes A₁, . . . , Aₘ in the discharge cells, due to the wall charges accumulated in the respective electrodes during the reset period PR. After the address period PA is terminated, positive wall charges are accumulated near the scan electrodes Y₁, . . . , Yₙ in the selected discharge cells, a large amount of negative wall charges are accumulated near the sustain electrodes X₁, . . . , Xₙ in the selected discharge cells, and a small amount of negative wall charges are accumulated near the address electrodes A₁, . . . , Aₘ in the selected discharge cells.

In the sustain period PS, a sustain discharge occurs in the discharge cells selected in the address period PA. In order to effect the sustain discharge, sustain pulses are alternately supplied to the scan electrodes Y₁, . . . , Yₙ and the sustain electrodes X₁, . . . , Xₙ. The number of the supplied sustain pulses depends on a gray-scale weight for each subfield. In order to enhance light emitting efficiency and improve brightness when the sustain discharge occurs, the third positive voltage Vₓ is supplied to the address electrodes A₁, . . . , Aₘ. The third voltage Vₓ can be lower than the first voltage Vₛ. The sustain pulse is alternately at the first positive voltage Vₛ and the second voltage V_{g}.

By supplying the sustain pulse and the third voltage Vₓ, a sustain discharge occurs in the discharge cells due to the wall charge accumulated in the discharge cells during the address period PA.

In more detail, if the first voltage Vₛ is supplied to the scan electrodes Y₁, . . . , Yₙ, the second voltage V_{g} supplied to the sustain electrodes X₁, . . . , Xₙ, and the third voltage Vₓ supplied to the address electrodes A₁, . . . , Aₘ, a sustain discharge begins between the sustain electrodes X₁, . . . , Xₙ and the address electrodes A₁, . . . , Aₘ in which a large amount of wall charges are accumulated. The sustain discharge is extended to between the sustain electrodes X₁, . . . , Xₙ and the scan electrodes Y₁, . . . , Yₙ. Due to the sustain discharge, a discharge volume is extended compared to other techniques, resulting in enhancing discharge efficiency and improving brightness.

After the sustain discharge occurs by the application of the third positive voltage Vₓ, negative wall charges are accumulated near the address electrodes A₁, . . . , Aₘ, negative wall charges are accumulated near the scan electrodes Y₁, . . . , Yₙ, and positive wall charges are accumulated near the sustain electrodes X₁, . . . , Xₙ. Then, if the second voltage V_{g} is supplied to the scan electrodes Y₁, . . . , Yₙ, the first voltage VS applied to the sustain electrodes X₁, . . . , Xₙ, and the third voltage Vₓ applied to the address electrodes A₁, . . . , Aₘ, a sustain discharge begins between the scan electrodes Y₁, . . . , Yₙ and the address electrodes A₁, . . . , Aₘ and the sustain discharge is extended to between the sustain electrodes X₁, . . . , Xₙ and the scan electrodes Y₁, . . . , Yₙ. Due to the sustain discharge, a discharge volume is extended compared to other techniques, resulting in enhanced discharge efficiency and improving brightness.

After the sustain discharge occurs by the application of the third positive voltage Vₓ, negative wall charges are accumulated near the address electrodes A₁, . . . , Aₘ, positive wall charges are accumulated near the scan electrodes Y₁, . . . , Yₙ, and negative wall charges are accumulated near the sustain electrodes X₁, . . . , Xₙ. As the sustain pulse is successively supplied according to gray-scale weights, the above operations are repeated.

In order to cause a sustain discharge to begin between the sustain electrodes X₁, . . . , Xₙ and the address electrodes A₁, . . . , Aₘ and between the scan electrodes Y₁, . . . , Yₙ and the address electrodes A₁, . . . , Aₘ and cause the sustain discharge to be smoothly extended to between the sustain electrodes X₁, . . . , Xₙ and the scan electrodes Y₁, . . . , Yₙ, the third voltage Vₓ must be within an appropriate range. Accordingly, the third voltage Vₓ is preferably smaller than the first voltage Vₛ, and it is sufficient if the third voltage Vₓ is approximately 0.5Vₛ.

FIG. 8 is a timing diagram of driving signals for driving the PDP of FIG. 3, according to another embodiment of the present invention. Hereinafter, the driving signals are described with reference to FIGS. 3 through 8.

In a reset period PR and an address period PA, the driving signals of FIG. 8 are supplied in the same manner as the driving signals of FIG. 7. However, in a sustain period PS, differently from the driving signals of FIG. 7, a sustain pulse is alternately supplied to the scan electrodes Y₁, . . . , Yₙ and the sustain electrodes X₁, . . . Xₙ, and the address electrodes A₁, . . . , Aₘ are floating. Floating is a state where no voltage is supplied. Since a first voltage Vₛ and a second voltage V_{g} are alternately supplied to the scan electrodes Y₁, . . . , Yₙ and the sustain electrode X₁, . . . , Xₙ, as shown in FIG. 8, a voltage of the address electrodes A₁, . . . , Aₘ positioned between the scan electrodes Y₁, . . . , Yₙ, and the sustain electrodes X₁, . . . , Xₙ becomes approximately half of the first voltage Vₛ, that is, 0.5Vₛ.

Accordingly, a sustain discharge occurs in the same manner as that described above with reference to FIG. 7. That is, if the first voltage Vₛ is supplied to the scan electrodes Y₁, . . . , Yₙ in the discharge cells, the second voltage V_{g} supplied to the sustain electrodes X₁, . . . , Xₙ in the discharge cells, and the address electrodes A₁, . . . , Aₘ are floating, a sustain discharge begins between the sustain electrodes X₁, . . . , Xₙ and the address electrodes A₁, . . . , Aₘ. The sustain discharge is extended to between the scan electrodes Y₁, . . . , Yₙ and the sustain electrodes X₁, . . . , Xₙ and thus a discharge volume is extended, resulting in enhanced discharge efficiency and brightness. Due to the sustain discharge, negative wall charges are accumulated near the scan electrodes Y₁, . . . , Yₙ, positive wall charges are accumulated near the sustain electrodes X₁, . . . , Xₙ, and negative wall charges are maintained near the address electrodes A₁, . . . , Aₘ.

Then, if the second voltage V_{g} is supplied to the scan electrodes Y₁, . . . , Yₙ in the discharge cells, the first voltage Vₛ supplied to the sustain electrodes X₁, . . . , Xₙ in the discharge cells, and the address electrodes are floating, a sustain discharge begins between the scan electrodes Y₁, . . . , Yₙ and the address electrodes A₁, . . . , Aₘ, and the sustain discharge is extended to between the scan electrodes Y₁, . . . , Yₙ and the sustain electrodes X₁, . . . , Xₙ. Since a discharge volume is extended due to the sustain discharge, discharge efficiency and brightness are improved. By the sustain discharge, positive wall charges are accumulated near the scan electrodes Y₁, . . . , Yₙ, negative wall charges are accumulated near the sustain electrodes X₁, . . . , Xₙ, and negative wall charges are maintained near the address electrodes A₁, . . . , Aₘ.

As the sustain pulse is successively supplied according to gray-scale weights, a sustain discharge continuously occurs in the discharge cells while the above operations are repeated.

As described above, according to the present invention, the following effects can be obtained.

First, in a PDP structure according to the present invention, visible light generated by discharge cells can be emitted through one or both the first substrate and the second substrate.

Second, since electrodes and dielectric layers are not disposed toward the first substrate and the second substrate, visible transparency is improved compared to the other arrangements.

Third, since respective electrodes are disposed in barrier ribs while surrounding discharge cells, a sustain discharge occurs in the form of a closed curve along the sides of each discharge cell and then is gradually diffused into the center of the discharge cell. Thus, since space charges in discharge cells, which are usually not utilized, contribute to light emission, light-emitting efficiency can be improved.

Fourth, in order to drive a PDP according to the present invention in which address electrodes are disposed between scan electrodes and sustain electrodes, by supplying a positive voltage to the address electrodes in a sustain period or floating the address electrodes, a sustain discharge begins between the scan electrodes (or the sustain electrodes) and the address electrodes and the sustain discharge is extended to between the scan electrodes and the sustain electrodes, resulting in enhanced discharge efficiency and brightness.

While the present invention has been particularly shown and described with reference to exemplary embodiments thereof, it will be understood by those of ordinary skill in the art that various modifications in form and detail can be made therein without departing from the spirit and scope of the present invention as defined by the following claims.

What is claimed is:

1. A Plasma Display Panel (PDP), comprising:
a first substrate and a second substrate separated from each other;
barrier ribs disposed between the first substrate and the second substrate and defining a plurality of discharge cells together with the first substrate and the second substrate;
a plurality of first electrodes and a plurality of second electrodes disposed in the barrier ribs and extending in a first direction parallel to each other;
a plurality of address electrodes disposed in the barrier ribs and extending in a second direction intersecting the first direction;
a plurality of phosphor layers disposed in the discharge cells; and
a discharge gas contained within the discharge cells;
wherein a unit frame is divided into a plurality of subfields having corresponding gray-scale weights for gray-scale display, each subfield being divided into a reset period during which the discharge cells are initialized, an address period during which discharge cells to be turned on are selected, and a sustain period during which a sustain discharge corresponding to the gray-scale weights occurs in the selected discharge cells; and
wherein either a sustain pulse alternately having an amplitude equal to a first voltage with positive polarity and a second voltage lower than the first voltage is alternately supplied to the first electrodes and the second electrodes during the sustain period, and a third voltage with positive polarity is supplied to the address electrodes during the sustain period, or the address electrodes are floating during the sustain period.

2. The PDP of claim 1, wherein the first electrodes, the second electrodes, and the address electrodes surround the discharge cells.

3. The PDP of claim 1, wherein the address electrodes are within the barrier ribs and are arranged between the first electrodes and the second electrodes.

4. The PDP of claim 1, wherein the phosphor layers are disposed on at least one of the first and second substrates.

5. The PDP of claim 1, wherein a reset pulse, comprising a rising pulse and a falling pulse, is supplied to the first electrodes during the reset period;
wherein a fourth voltage with positive polarity is supplied to the second electrodes from when the falling pulse is supplied during the reset period;
wherein a second voltage is supplied to the address electrodes during the reset period;
wherein a scan pulse is supplied to the first electrodes during the address period;
wherein the fourth voltage is supplied to the second electrodes during the address period; and
wherein an address pulse is supplied to the address electrodes in synchronism with the scan pulse during the address period.

6. The PDP of claim 5, wherein the rising pulse amplitude rises by a fifth voltage from the first voltage and finally reaches a sixth voltage;
wherein the falling pulse amplitude falls from the first voltage and finally reaches a seventh voltage;
wherein the scan pulse sequentially has an amplitude equal to an eighth voltage and a ninth voltage lower than the eighth voltage; and
wherein the address pulse has an amplitude equal to a tenth voltage with a positive polarity.

7. The PDP of claim 1, wherein the third voltage is lower than the first voltage.

8. The PDP of claim 1, wherein the second voltage is a ground voltage.
